(19) United States
(12) Patent Application Publication
(10) Pub. No.: US 2026/0188990 A1
(43) Pub. Date: Jul. 2, 2026

(54) TRANSMISSION TOWER

(71) Applicant: SHANGHAI SHEMAR POWER ENGINEERING CO., LTD., Shanghai (CN)

(72) Inventors: Xinlong WANG, Shanghai (CN); Chen WANG, Shanghai (CN); Yanlin LI, Shanghai (CN)

(73) Assignee: SHANGHAI SHEMAR POWER ENGINEERING CO., LTD., Shanghai (CN)

(21) Appl. No.: 18/857,324

(22) PCT Filed: Jun. 21, 2024
(86) PCT No.: PCT/CN2024/100550

§ 371 Date: Oct. 16, 2024

(30) Foreign Application Priority Data
Jun. 28, 2023 (CN) 202321673738.5
Jun. 28, 2023 (CN) 202321673757.8

(51) Int. Cl. H02G 7/20; E04H 12/24; H02G 7/02; H02G 7/22

(52) U.S. Cl. CPC H02G 7/20; E04H 12/24; H02G 7/02; H02G 7/22

(57) ABSTRACT

The present disclosure discloses a transmission tower, including a tower body and a composite crossarm disposed on the tower body. The composite crossarm includes at least one insulator and an end fitting. The end fitting is connected to a high-voltage end of the insulator to form an end part of the composite crossarm for attaching a first conductor. The end fitting includes a connecting part. The connecting part is provided with two wire attaching plates and a jumper connector. The two wire attaching plates are distributed on two sides of the connecting part in an extending direction of the first conductor. A first jumper is electrically connected to first conductors located on two sides of the tower body and is attached on the jumper connector. The present application applies the composite crossarm to the tension tower, achieving a connection node structure having a simple, novel, and beautiful, a clear force transmission path, which is convenient for transportation and subsequent operation and maintenance, increases the overall stability of a transmission line tower, and improves the safety of the transmission line.

### TECHNICAL FIELD

The present disclosure relates to the technical field of electricity power transmission, and in particular to a transmission tower.

### BACKGROUND

At present, composite crossarm straight-line towers have gradually begun to be applied in batches in transmission lines at home and abroad, and have achieved good economic and technical results. However, there are few application results of composite crossarm tension towers in transmission lines at home and abroad. For transmission lines, corner towers and tension towers occupy an important position in the design of transmission line engineering, which is of great significance to the development of EPC general contracting business of transmission lines at home and abroad. Therefore, it is urgent to design a composite crossarm tension tower.

### SUMMARY

A main object of the present disclosure is to provide a transmission tower, in which a composite crossarm is applied to a tension tower, with a connection node structure that is simple, novel, and aesthetic, and provides a clear force transmission path, which is convenient for transportation as well as subsequent operation and maintenance, increases the overall stability of a transmission line tower, and improves the safety of the transmission line.

In order to solve the above technical problems, the technical solution adopted in the present disclosure is as follows: a transmission tower is provided, including a tower body and a composite crossarm disposed on the tower body. The composite crossarm includes at least one insulator and an end fitting. The end fitting is connected to a high-voltage end of the insulator to form an end part of the composite crossarm for attaching a first conductor. The end fitting includes a connecting part. The connecting part is provided with two wire attaching plates and a jumper connector. The two wire attaching plates are distributed on two sides of the connecting part in an extending direction of the first conductor. A first jumper is electrically connected to first conductors located on two sides of the tower body and is attached on the jumper connector.

Among others, the connecting part is cylindrical.

Among others, the wire attaching plates and the jumper connector are connected to an outer periphery of the connecting part.

Among others, a first connecting plate and a second connecting plate are further disposed at two ends of the connecting part. The first connecting plate covers an end of the end fitting away from the insulator. The second connecting plate extends outward from another end of the connecting part in a radial direction of the connecting part to form a fully surrounding structure.

Among others, construction holes are provided on each of the first connecting plate and the second connecting plate.

Among others, the transmission tower further includes a tension fitting. A first mounting hole is provided on each wire attaching plate. An end of the tension fitting is fixedly connected to the first mounting hole, and another end of the tension fitting is configured to attach the first conductor.

Among others, the tension fitting includes: a first tension connecting plate, a second tension connecting plate spaced apart from the first tension connecting plate; and two first tension connectors, each having a first end connected to the first tension connecting plate, and a second end connected to the second tension connecting plate.

Among others, the tension fitting includes a first tension connecting plate, two first tension connectors and two second tension connectors. The two second tension connectors are in one-to-one correspondence with the two first tension connectors. The two second tension connectors are connected to the first tension connecting plate by respective first tension connectors.

Among others, the jumper connector is located at a bottom of the connecting part, and located between the two wire attaching plates. A wire-attaching fitting string is attached on the jumper connector and configured to attach the first jumper.

Among others, two composite crossarms are disposed on the tower body at a same height, and are axially symmetrically distributed relative to an axis of the tower body. The two composite crossarms have axes coinciding with each other, to form a composite crossarm assembly. Three composite crossarm assemblies are arranged on the tower body from bottom to top sequentially, and configured to attach double-circuit conductors.

Among others, two composite crossarms are disposed on the tower body at a same height, and are axially symmetrically distributed relative to an axis of the tower body. The two composite crossarms have axes coinciding with each other, to form a composite crossarm assembly. Six composite crossarm assemblies are arranged on the tower body from bottom to top sequentially, and configured to attach four-circuit conductors.

Among others, the transmission tower further includes: an earth wire peak disposed at a top of the tower body; a jumper string vertically attached at an end of the earth wire peak away from the tower body; and a tension insulator string disposed on the tower body and positioned below the jumper string. A second jumper is attached between the tension insulator string and the jumper string. The composite crossarm is located below the tension insulator string. An end of the tension insulator string away from the tower body is configured to attach a second conductor.

Among others, the tension insulator string includes: two tension insulators disposed parallel to each other; a first fixing fitting; and a second fixing fitting. A first end of each of the two tension insulators is fixedly connected to the tower body by the first fixing fitting, and a second end of each of the two tension insulators is configured to attach the second conductor by means of the second fixing fitting.

Among others, two tension insulator strings are provided. The two tension insulator strings are symmetrically distributed on the two sides of the tower body in an extending direction of the second conductor.

Among others, the first fixing fitting includes a first yoke plate, a first adjusting fitting and second adjusting fittings. An end of the first yoke plate adjacent to the tower body is connected to the tower body by the first adjusting fitting, and another end of the first yoke plate is fixedly connected to the tension insulators by the second adjusting fittings.

Among others, the second fixing fitting includes a second yoke plate and a third adjusting fitting. An end of the second yoke plate adjacent to the tower body is directly fixedly connected to the tension insulators, and another end of the second yoke plate is connected to the second conductor in an adjustable position by means of the third adjusting fitting.

Among others, the third adjusting fitting includes a DB-type of adjusting plate and a U-type fitting. The DB-type adjusting plate is provided with a plurality of mounting parts that are arranged in an arc shape. The U-type fitting is selectively connected to one of the mounting parts.

Among others, a fixing part is provided on the top of the tower body. An end of the earth wire peak is fixedly connected to the tower body by the fixing part, and another end of the earth wire peak is connected to the jumper string.

Among others, the jumper string includes, two jumper insulators disposed parallel to each other, a third fixing fitting, and a wire attaching fitting. First ends of the two jumper insulators are fixedly connected to the earth wire peak by the third fixing fitting, and second ends of the two jumper insulators are configured to attach the second jumper by means of the wire attaching fitting.

Among others, the second jumper is electrically connected to second conductors located on the two sides of the tower body.

The composite crossarm of the present disclosure is applicable to the tension tower, and the composite crossarm includes at least one insulator; the high-voltage end of at least one insulator is connected together by the end fitting to form the end part of the composite crossarm for attaching the conductor; and the end fitting can be configured to have a single attaching point (where one first mounting hole is provided on the tension fitting) or two attaching points (where two first mounting holes are provided on the tension fitting), which can achieve the following technical effects. 1) It can be ensured that consideration is given to normal design as well as the designs of crossing high-speed railways, expressways, and important transmission corridors, and it can ensure that the composite crossarm is uniformly stressed, the difficulty of mounting the composite crossarm is reduced, and mounting time and cost can be saved. 2) The processing accuracy of the composite crossarm can be reduced. 3) The spacing between the layers of conductors can be reduced, the corridor width can be shortened, the size of the tower head can be reduced, and the electric field distribution and electromagnetic environment of the tension tower can be improved. 4) The load effect of the conductors and wind load on the tower head can be reduced, and the tower weight and forces acting on the foundation can be reduced. 5) The application problem of the conventional tension towers in areas with limited corridors and high land acquisition requirements can be solved. 6) The investment and operation and maintenance costs of the transmission lines and the entire life cycle thereof can be reduced, and free operation and maintenance throughout the life cycle can be achieved.

### BRIEF DESCRIPTION OF THE DRAWINGS

In order to more clearly illustrate the technical solutions of the present disclosure, the drawings required for use in the description of the embodiments will be briefly introduced below. Apparently, the drawings described below are only some embodiments of the present disclosure. For ordinary skills in the art, other drawings can be obtained based on these drawings without paying creative work, in which:

FIG. 1 is a schematic structural view of a transmission tower according to a first embodiment of the present disclosure;

FIG. 2 is an enlarged schematic view of portion A in FIG. 1;

FIG. 3 is a schematic structural view of an end fitting according to an embodiment of the present disclosure;

FIG. 4 is a schematic structural view showing a connection between an end fitting and an insulator according to another embodiment of the present disclosure;

FIG. 5 is a schematic structural view of an end fitting according to another embodiment of the present disclosure;

FIG. 6 is a schematic structural view of a transmission tower of a second embodiment of the present disclosure;

FIG. 7 is a schematic structural view of a transmission tower of a third embodiment of the present disclosure;

FIG. 8 is an enlarged schematic view of portion B in FIG. 7;

FIG. 9 is an enlarged schematic view of portion C in FIG. 7; and

FIG. 10 is an enlarged schematic view of portion D in FIG. 7.

### DETAILED DESCRIPTION

The technical solutions in the embodiments of the present disclosure are clearly and completely described below in conjunction with the drawings in the embodiments of the present disclosure. Apparently, the described embodiments are only part of the embodiments of the present disclosure, not all of the embodiments. Based on the embodiments in the present disclosure, all other embodiments obtained by ordinary skills in the art without creative work are within the scope of protection of the present disclosure.

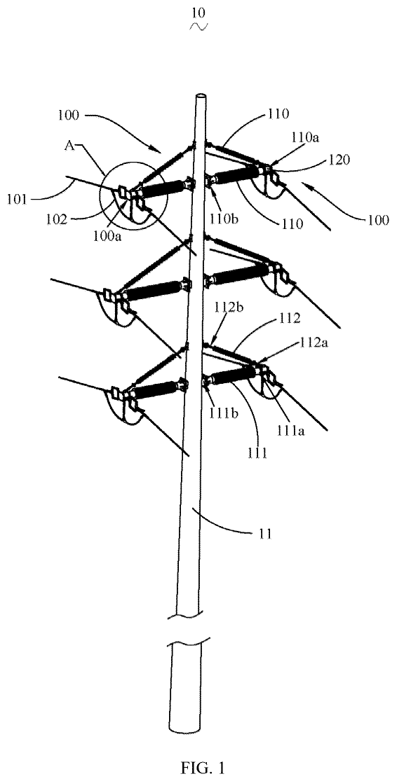

Referring to FIG. 1, the present disclosure provides a transmission tower 10. The transmission tower 10 includes a tower body 11 and a composite crossarm 100 disposed on the tower body 11. The composite crossarm 100 includes at least one insulator 110 and an end fitting 120. A low-voltage end 110b of the at least one insulator 110 is configured to be connected to the tower body 11, and a high-voltage end 110a of the at least one insulator 110 is connected together by the end fitting 120 to form an end part 100a of the composite crossarm 100 configured for attaching a conductor. As such, the stability of all insulators 110 that are connected together can be ensured, thereby ensuring that the composite crossarm 100 is stable and strong.

One or more composite crossarms 100 may be arranged only on one side of the tower body 11, or the composite crossarms 100 may be arranged on two symmetrical sides of the tower body 11. One or more insulators 110 may be provided, and which is no limited herein. The insulator 110 has the low-voltage end 110b and the high-voltage end 110a. The low-voltage end 110b is connected to the tower body 11. The high-voltage end 110a of the at least one insulator 110 is connected together to form the end part 100a of the composite crossarm 100, for attaching the conductor. When one insulator 110 is provided, the high-voltage end 110a of the insulator 110 forms the end part 100a of the composite crossarm 100, and when a plurality of insulators 110 are provided, the high-voltage ends 110a of the plurality of insulators 110 are connected together to form the end part 100a of the composite crossarm 100. Meanwhile, in this embodiment, the conductor attached to the end part 100a of the composite crossarm 100 is defined as a first conductor 101.

Referring to FIG. 1, the transmission tower 10 is a tension tower 10, and three composite crossarms 100 are arranged on each of two symmetrical sides of the tower body 11. The tower body 11 is in a pole structure, and specifically, may be a steel pipe pole, a wooden pole, or a composite pole made of composite materials. In other embodiments, the tower body of the transmission tower can also be a lattice structure, such as a lattice iron tower, which is not limited herein.

Referring to FIGS. 1 to 3, in an extending direction of the first conductor 101, the first conductors 101 on two sides of the tower body 11 are disconnected. Each of the first conductors 101 on the two sides of the tower body 11 is fixedly connected to the tower body 11 through the end fitting 120. The first conductors 101 on the two sides of the tower body 11 are electrically connected to each other by a first jumper 102.

The end fitting 120 includes a connecting part 121. The connecting part 121 is configured to be connected to the high-voltage end 110a of the at least one insulator 110. The connecting part 121 is provided with two wire attaching plates 122 and a jumper connector 123. The two wire attaching plates 122 are distributed on two sides of the connecting part 121 in the extending direction of the first conductor 101. The first jumper 102 is electrically connected to the first conductors 101 located on the two sides of the tower body 11 and is attached to the jumper connector 123. The connecting part 121 has a cylindrical structure. The wire attaching plates 122 and the jumper connector 123 are each connected to the outer periphery of the connecting part 121.

The wire attaching plate 122 is configured to connect the first conductor 101. In the extending direction of the first conductor 101, the first conductor 101 on one of the two sides of the tower body 11 is tensioned by a tension clamp, which is connected to one of the wire attaching plates 122 of the end fitting 120 by a tension fitting 130. In addition, the first conductor 101 on another of the two sides of the tower body 11 is also tensioned by another tension clamp, which is connected to another of the wire attaching plates 122 of the end fitting 120 by another tension fitting 130. That is, in the extending direction of the first conductor 101, the first conductors 101 located on the two sides of the tower body 11 are respectively attached to the two wire attaching plates 122 on the two sides of the connecting part 121 by two tension fittings 130. The first jumper 102 is electrically connected between the tension clamps on the two sides of the tower body 11 to achieve power transmission. Certainly, in other embodiments, the two wire attaching plates may not be located on the two sides of the connecting part in the extending direction of the conductor, as long as it can be ensured that the two wire attaching plates can be connected to the conductors on the two sides of the tower body respectively.

The jumper connector 123 is configured to attach the first jumper 102. The jumper connector 123 is located at the bottom of the connecting part 121, and is located between the two wire attaching plates 122. A wire-attaching fitting string 140 is attached on the jumper connector 123, and then the first jumper 102 is attached by the wire-attaching fitting string 140. The jumper connector 123 may have the same configuration as that of the wire attaching plate 122, for example, the jumper connector 123 and the wire attaching plate 122 are both configured as plate-shaped structures. The wire attaching plate 122 and the jumper connector 123 are both connected to the connecting part 121 to ensure that the end fitting 120 has a compact structure and can achieve high connection strength.

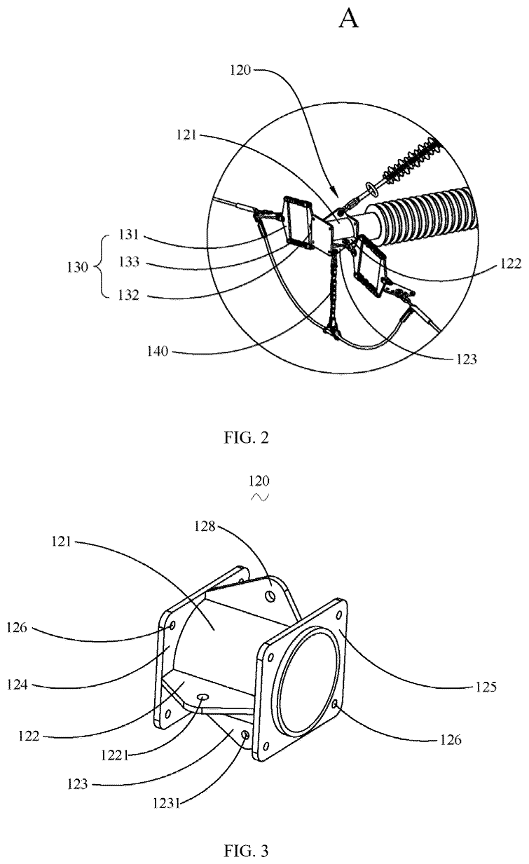

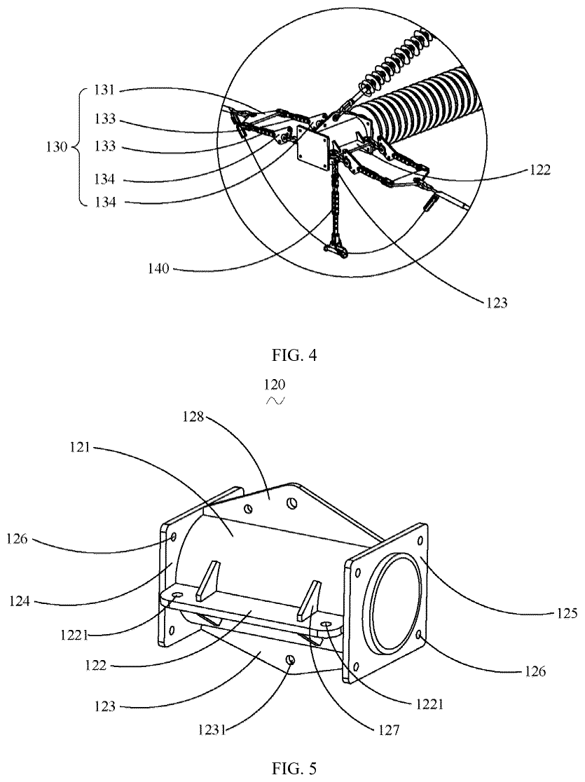

Continuing to refer to FIGS. 2 and 3, in order to realize the connection between the tension fitting 130 and the wire attaching plate 122, a first mounting hole 1221 may be further provided on the wire attaching plate 122. An end of the tension fitting 130 is fixedly connected to the first mounting hole 1221, and another end of the tension fitting 130 is configured to attach the first conductor 101. In this embodiment, the wire attaching plate 122 is provided with one first mounting hole 1221. The tension fitting 130 is connected to the wire attaching plate 122 through the first mounting hole 1221. In this case, the tension fitting 130 includes a first tension connecting plate 131, a second tension connecting plate 132 and a first tension connector 133. The first tension connecting plate 131 and the second tension connecting plate 132 are spaced apart from each other. In order to ensure the connection strength between the first tension connecting plate 131 and the second tension connecting plate 132, two first tension connector 133 are provided. First ends of the two first tension connector 133 are both connected to the first tension connecting plate 131, and second ends of the two first tension connector 133 are both connected to the second tension connecting plate 132. Moreover, the first tension connecting plate 131 is connected to the tension clamp to connect the first conductor 101. The second tension connecting plate 132 is connected to the wire attaching plate 122 through the first mounting hole 1221.

Continuing to refer to FIG. 3, the end fitting 120 further includes a first connecting plate 124 and a second connecting plate 125. The first connecting plate 124 and the second connecting plate 125 are respectively located at two end surfaces of the connecting part 121. The first connecting plate 124 covers the end of the end fitting 120 away from the insulator 110 to prevent moisture, impurities, etc. from penetrating into the insulator 110. The second connecting plate 125 extends outward from another end of the connecting part 121 in the radial direction of the connecting part 121 to form a fully surrounding structure. The wire attaching plate 122 and the jumper connector 123 are both located between the first connecting plate 124 and the second connecting plate 125.

In addition, construction holes 126 are provided on each of the first connecting plate 124 and the second connecting plate 125 in the circumferential direction, for lifting the composite crossarm 100 and for tightening and attaching the conductor.

In order to ensure that the tension fittings 130 are evenly stressed, the tension fittings 130 are symmetrical in structure. In an application scenario, as shown in FIG. 2, the first tension connecting plate 131 and the second tension connecting plate 132 have the same configuration, and have a structure of plate. A plurality of connection holes are provided on the surface of such plate, and are configured to be connected to the tension clamp, the first tension connector 133, and the first mounting hole 1221 respectively. Two first tension connectors 133 are disposed parallel to each other. The first tension connector 133 can be adopted as a common link fitting, such as a fitting combined with a U-shaped ring and an adjusting plate.

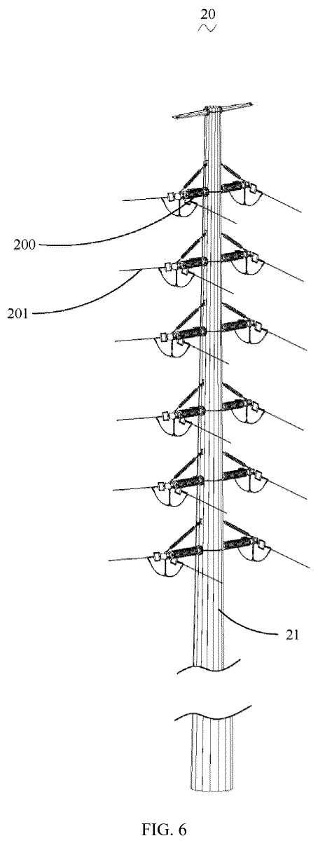

In another embodiment, referring to FIGS. 4 and 5, the wire attaching plate 122 is provided with two first mounting holes 1221. The tension fitting 130 is connected to the wire attaching plate 122 through the two first mounting holes 1221, which can further ensure the connection strength between the tension fitting 130 and the wire attaching plate 122, and ensure that the transmission tower 10 can achieve large crossing overhead lines for example, spanning crossing railways, highways, canals or the like. In this case, the tension fitting 130 include the first tension connecting plate 131, two first tension connectors 133, and two second tension connectors 134.

The first tension connecting plate 131 is connected to the tension clamp to connect the first conductor 101. The two second tension connectors 134 are in one-to-one correspondence with the two first tension connectors 133. The two second tension connectors 134 are connected to the first tension connecting plate 131 by respective first tension connectors 133. The two second tension connectors 134 are in one-to-one correspondence with the two first mounting holes 1221. Each of the two second tension connectors 134 is connected to the wire attaching plate 122 by the first mounting hole 1221. The second tension connectors 134 can be adopted as common fittings such as DB-type adjusting plates.

Referring to FIG. 5, a reinforcing plate 127 is disposed between the wire attaching plate 122 and the connecting part 121. The reinforcing plate 127 is connected with both the surface of the wire attaching plate 122 and the outer peripheral surface of the connecting part 121. The reinforcing plates 127 are disposed on the two surfaces of the wire attaching plate 122, so that the end fitting 120 has a more stable structure.

Similarly, in order to ensure that the tension fitting 130 is subjected to uniform force, the tension fitting 130 also has a symmetrical structure, and the symmetry axis of the tension fitting 130 coincides with the symmetry axis of the first tension connecting plate 131.

Certainly, in other embodiments, three, four or more first mounting holes 1221 may also be provided on the wire attaching plate 122, which is not limited herein.

Referring to FIGS. 2 to 5, in order to achieve the connection between the jumper connector 123 and the wire-attaching fitting string 140, a second mounting hole 1231 is further provided on the jumper connector 123, and is configured to be connected to the wire-attaching fitting string 140. Similar to the first mounting hole 1221, one, two or more second mounting holes 1231 may be provided on the jumper connector 123, which is no limited herein.

The connecting part 121, the wire attaching plate 122, and the jumper connector 123 may be integrally formed, or may be connected together by welding or other methods.

Continuing to refer to FIG. 1, in an embodiment, each composite crossarm 100 includes two insulators 110, which specifically are a post insulator 111 and a suspension insulator 112. A high-voltage end 111a of the post insulator 111 and a high-voltage end 112a of the suspension insulator 112 are connected to each other. A low-voltage end 111b of the post insulator 111 and a low-voltage end 112b of the suspension insulator 112 are respectively connected to the tower body 11 at two different positions. In this case, the composite crossarm 100 presents a stable triangular structure, which can ensure the stability of the composite crossarm 100. The suspension insulator 112 is located above the post insulator 111.

Referring to FIGS. 3 and 5, a connecting lug 128 is further disposed on the outer periphery surface of the connecting part 121, and is configured to be connected to the suspension insulator 112. The connecting lug 128 is located at the top of the connecting part 121 and between the two wire attaching plates 122. The connecting lug 128 is provided with a connection hole configured to be connected to the suspension insulator 112, so that the high-voltage end 111a of the post insulator 111 and the high-voltage end 112a of the suspension insulator 112 are connected together by the end fitting 120 to form the end part 100a of the composite crossarm 100 for attaching the conductor.

In other embodiments, a plurality of post insulators and a plurality of suspension insulators may be provided, and the number of post insulators and suspension insulators are not limited in the present disclosure. The configuration of the end fitting may be adaptively designed for matching.

For example, two post insulators may be provided, and one suspension insulator may be provided. The suspension insulator is located on the same side of the two post insulators. The arrangement of the two post insulators and one suspension insulator enables a stable triangular structure to be formed between the composite crossarm and the tower body of the transmission tower, which can greatly improve the stability of the composite crossarm. In this case, the two post insulators have the same mounting heights; the two post insulators are arranged in a V shape; and the suspension insulator is located above the two post insulators.

For another example, two post insulators may be provided, and two suspension insulators may be provided. The two suspension insulators are located on the same side of the two post insulators and are respectively disposed adjacent to the two post insulators. The arrangement of the two post insulators and the two suspension insulators enables a stable triangular structure to be formed between the composite crossarm and the tower body of the transmission tower, which can greatly improve the stability of the composite crossarm. In this case, the two post insulators have the same mounting heights; the two suspension insulators have the same mounting heights; and the two suspension insulators are both located above the two post insulators.

Continuing to refer to FIG. 1, in an embodiment, two composite crossarms 100 are disposed on the tower body 11 of the transmission tower 10 at the same height. The two composite crossarms 100 are axially symmetrically distributed relative to the axis of the tower body 11. The axes of the two composite crossarms 100 coincide with each other. The two symmetrically distributed composite crossarms 100 form a composite crossarm assembly. Two ends of the composite crossarm assembly far away from the tower body 11 form two end parts for attaching the conductors, which are respectively configured to attach two first conductors 101. Three composite crossarm assemblies are disposed on the tower body 11 from bottom to top, so that six end parts for attaching the conductors are formed, which can attach six first conductors 101, that is, the transmission tower 10 can be used for attaching double-circuit conductors.

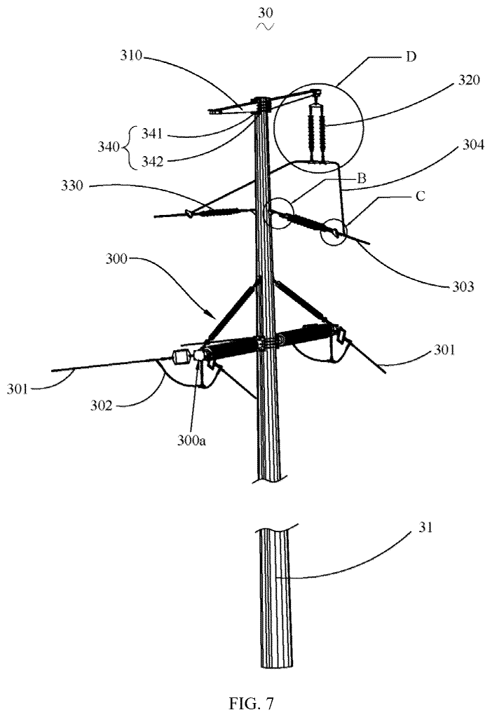

Referring to FIG. 6, in another embodiment, six composite crossarm assemblies are sequentially arranged on the tower body 21 of the transmission tower 20 from bottom to top. In this way, twelve end parts for attaching the conductors are formed, which can attach twelve first conductors 201, that is, the transmission tower 20 can be used for attaching four-circuit conductors. Compared with the conventional iron crossarm, the composite crossarm used for the four-circuit transmission lines on the same tower in this embodiment can effectively reduce the width of the line corridor, greatly reduce the tower height, increase the transmission capacity of the tower body, and enhance the line reliability, which is of great significance to the development of power transmission projects.

Certainly, in other embodiments, the tower body of the transmission tower may also have other numbers of composite crossarms, and may be used to attach a single-circuit conductor or multiple-circuit conductors, which is not limited herein.

In another embodiment, referring to FIG. 7, the transmission tower 30 includes a tower body 31, an earth wire peak 310, a jumper string 320, a tension insulator string 330 and a composite crossarm 300. The earth wire peak 310 is disposed at the top of the tower body 31. The jumper string 320 is vertically attached at an end of the earth wire peak 310 away from the tower body 31. The tension insulator string 330 is disposed on the tower body 31 and positioned below the jumper string 320. A jumper is attached between the tension insulator string 330 and the jumper string 320. The composite crossarm 300 is disposed below the tension insulator string 330. The ends of the tension insulator string 330 and the composite crossarm 300 away from the tower body 31 are used to attach the conductors. That is, the earth wire peak 310, the jumper string 320, the tension insulator string 330 and the composite crossarm 300 are disposed on the tower body 31 in sequence from top to bottom.

The specific configuration of the composite crossarm 300 is the same as that of the composite crossarm 100, and which will not be repeatedly described in detail herein. An end part 300a of the composite crossarm 300 is configured to attach a first conductor 301. In the extending direction of the first conductor 301, the first conductors 301 on the two sides of the tower body 31 are disconnected. The first conductors 301 on the two sides of the tower body 31 are respectively fixedly connected to the end parts 300a of the composite crossarms 300. The first conductors 301 on the two sides of the tower body 31 are electrically connected to each other through a first jumper 302, which is similar to the above relevant description, and will not be repeatedly described in detail herein.

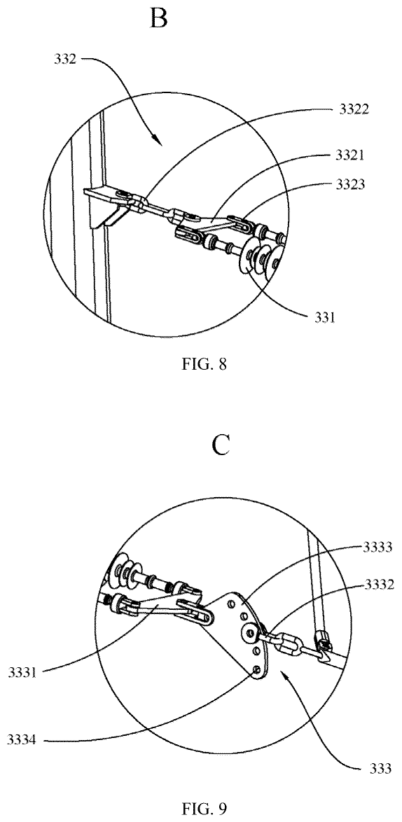

As shown in FIGS. 8 and 9, the tension insulator string 330 includes two tension insulators 331, a first fixing fitting 332 and a second fixing fitting 333. The two tension insulators 331 are disposed parallel to each other. First ends of the two tension insulators 331 are fixedly connected to the tower body 31 by the first fixing fitting 332, and second ends of the two tension insulators 331 are configured to attach conductors by means of the second fixing fitting 333. In this embodiment, the conductor attached by the tension insulator string 330 is defined as a second conductor 303, and the jumper attached between the tension insulator string 330 and the jumper string 320 is defined as a second jumper 304.

Two tension insulator strings 330 are symmetrically distributed on both sides of the tower body 31 in the extending direction of the second conductor 303. In the extending direction of the second conductor 303, the second conductors 303 on the two sides of the tower body 31 are disconnected. The second conductors 303 on the two sides of the tower body 31 are respectively attached to the ends of the tension insulators 331 away from the tower body 31 by means of the second fixing fittings 333. The second conductors 303 on the two sides of the tower body 31 are electrically connected by the second jumper 304.

Referring to FIG. 8, the first fixing fitting 332 includes a first yoke plate 3321, a first adjusting fitting 3322 and second adjusting fittings 3323. An end of the first yoke plate 3321 adjacent to the tower body 31 is connected to the tower body 31 by the first adjusting fitting 3322, and another end of the first yoke plate 3321 is fixedly connected to the two tension insulators 331 by the second adjusting fittings 3323.

The first yoke plate 3321 is a triangular yoke plate. Three third mounting holes are respectively provided at the three vertex corners of the first yoke plate 3321. The third mounting hole at one vertex corner is connected to the first adjusting fitting 3322, and the third mounting holes at the other two vertex corners are respectively connected to the second adjusting fittings 3323 to which the tension insulators 331 are connected. In this embodiment, the first yoke plate 3321 is an isosceles triangular plate. In other embodiments, the first yoke plate may also be in any other triangular plate shape, which will not be described in detail herein.

The first adjusting fitting 3322 includes a plurality of U-shaped fittings and a plurality of annular fittings. In this embodiment, two U-shaped fittings are provided, and one annular fitting is provided. The two U-shaped fittings are sleeved on both ends of the annular fitting. In other embodiments, the number of U-shaped fittings and the number of annular fittings may also be provided according to actual use, and one end of the first yoke plate 3321 is fixedly connected to the tower body 31 in an adjustable position.

The second adjusting fitting 3323 includes two Z-shaped clevises. First ends of the two Z-shaped clevises are respectively connected to the third mounting holes at two vertex corners of the first yoke plate 3321, and second ends of the two Z-shaped clevises are respectively fixedly connected to the two tension insulators 331. According to actual use, Z-shaped clevis of different lengths can be selected to adjust the distance between the tension insulator 331 and the tower body 31.

In other embodiments, the second adjusting fitting may be omitted, and in this case, the tension insulator may be directly fixed to the first yoke plate by fasteners or other means, depending on actual use, and which is not limited herein.

Referring to FIG. 9, the second fixing fitting 333 includes a second yoke plate 3331 and a third adjusting fitting 3332. An end of the second yoke plate 3331 adjacent to the tower body 31 is directly fixedly connected to the tension insulator 331, and another end of the second yoke plate 3331 is connected to the second conductor 303 in an adjustable position by means of the third adjusting fitting 3332.

The second yoke plate 3331 is a triangular yoke plate. Three fourth mounting holes are respectively provided at the three vertex corners of the second yoke plate 3331. Two fourth mounting holes at two vertex corners are respectively connected to two tension insulators 331, and the fourth mounting hole at another vertex corner is connected to the third adjustment fitting 3332 to which the second conductor 303 is attached. In this embodiment, the second yoke plate 3331 is an isosceles triangular plate. In other embodiments, the second connecting plate may also be in any other triangular plate shape, which will not be described in detail herein.

The third adjusting fitting 3332 includes a Z-shaped clevis, a DB-type adjusting plate 3333, a U-shaped fitting and an annular fitting that are connected in sequence. An end of the Z-shaped clevis is connected to the fourth mounting hole at one of the convex corners of the second yoke plate 3331, and another end of the Z-shaped clevis is connected to the DB-type adjusting plate 3333. The DB-type adjusting plate 3333 is fan-shaped as a whole, and is provided with a plurality of mounting parts 3334 that are arranged in an arc shape. The U-shaped fitting may be selectively connected to one of the mounting parts 3334, so that the third adjusting fitting 3332 can be connected to the second conductor 303 in an adjustable position.

In order to mount the second jumper 304, the jumper string 320 is disposed at the top of the tower body 31 to support the second jumper 304. Specifically, two earth wire peaks 310 are disposed at the top of the tower body 31. The earth wire peaks 310 are wedge-shaped, and the two earth wire peaks 310 are symmetrically disposed on the two sides of the tower body 31. A fixing part 340 is disposed at the top of the tower body 31. An end of the earth wire peak 310 is fixedly connected to the tower body 31 by the fixing part 340, and another end of the earth wire peak 310 is connected to the jumper string 320. The fixing part 340 includes a connecting plate 341 and a plurality of reinforcing plates 342. A side of the connecting plate 341 is connected to the outer peripheral surface of the tower body 31. The plurality of reinforcing plates 342 are connected between the connecting plate 341 and the tower body 31, so that the fixing part 340 has a more stable structure.

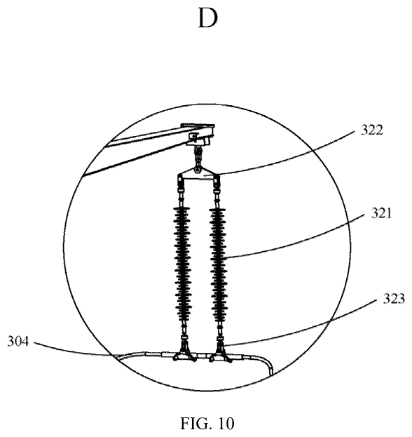

Referring to FIG. 10, the jumper string 320 includes two jumper insulators 321, a third fixing fitting 322 and a wire attaching fitting 323. The two jumper insulators 321 are disposed parallel to each other. First ends of the two jumper insulators 321 are fixedly connected to the earth wire peak 310 by means of the third fixing fitting 322, and second ends of the two jumper insulators 321 are configured to attach the second jumper 304 by means of the wire attaching fittings 323. The second jumper 304 is electrically connected to the second conductors 303 located on the two sides of the tower body 31.

The third fixing fitting 322 has a similar configuration to the first fixing fitting 332, except that a first adjusting fitting of the third fixing fitting 322 is connected to the earth wire peak 310, and a second adjusting fitting of the third fixing fitting 322 is connected to the jumper insulator 321.

The wire attaching fitting 323 includes a fourth adjusting fitting and a wire attaching clamp. An end of the fourth adjusting fitting is connected to the end of the jumper insulator 321 away from the earth wire peak 310, and another end of the fourth adjusting fitting is connected to the wire attaching clamp to attach the second jumper 304. According to actual use, the fourth adjusting fitting of different lengths can be selected to adjust the height of the attached second jumper 304.

In this embodiment, the jumper string 320 is disposed at the upper phase and the composite crossarm 300 is disposed at the lower phase to attach the three-phase conductors, eliminating the use of the composite crossarm at the upper phase, enabling the transmission tower 30 in the form of a tension tower to be simpler in structure and easier to mount. In other embodiments, different numbers of composite crossarms and jumper strings may be disposed on the tower body to attach conductors of different circuits.

In summary, the composite crossarm of the present disclosure is applicable to the tension tower, and the composite crossarm includes at least one insulator; the high-voltage end of at least one insulator is connected together by the end fitting to form the end part of the composite crossarm for attaching the conductor; and the end fitting can be configured to have a single attaching point (where one first mounting hole is provided on the tension fitting) or two attaching points (where two first mounting holes are provided on the tension fitting), which can achieve the following technical effects. 1) It can be ensured that consideration is given to normal design as well as the designs of crossing high-speed railways, expressways, and important transmission corridors, and it can ensure that the composite crossarm is uniformly stressed, the difficulty of mounting the composite crossarm is reduced, and mounting time and cost can be saved. 2) The processing accuracy of the composite crossarm can be reduced. 3) The spacing between the layers of conductors can be reduced, the corridor width can be shortened, the size of the tower head can be reduced, and the electric field distribution and electromagnetic environment of the tension tower can be improved. 4) The load effect of the conductors and wind load on the tower head can be reduced, and the tower weight and forces acting on the foundation can be reduced. 5) The application problem of the conventional tension towers in areas with limited corridors and high land acquisition requirements can be solved. 6) The investment and operation and maintenance costs of the transmission lines and the entire life cycle thereof can be reduced, and free operation and maintenance throughout the life cycle can be achieved.

The above description only illustrates implementations of the present disclosure, and does not limit the patent scope of the present disclosure. Any equivalent structure or equivalent process variants, made based on the specification and drawings of the present disclosure, or directly or indirectly used in other related tar, are also included in the patent protection scope of the present disclosure.

1. A transmission tower, comprising:
a tower body; and
a composite crossarm disposed on the tower body, wherein the composite crossarm includes at least one insulator and an end fitting,
wherein the end fitting is connected to a high-voltage end of the insulator to form an end part of the composite crossarm for attaching a first conductor,
the end fitting includes a connecting part, the connecting part being provided with two wire attaching plates and a jumper connector, and wherein the two wire attaching plates are distributed on two sides of the connecting part in an extending direction of the first conductor, and a first jumper is electrically connected to first conductors located on two sides of the tower body and is attached on the jumper connector.

2. The transmission tower according to claim 1, wherein the connecting part is cylindrical.

3. The transmission tower according to claim 2, wherein the wire attaching plates and the jumper connector are connected to an outer periphery of the connecting part.

4. The transmission tower according to claim 2, further comprising a first connecting plate and a second connecting plate disposed at two ends of the connecting part;
wherein the first connecting plate covers an end of the end fitting away from the insulator, and the second connecting plate extends outward from another end of the connecting part in a radial direction of the connecting part to form a fully surrounding structure.

5. The transmission tower according to claim 4, further comprising construction holes are provided on each of the first connecting plate and the second connecting plate.

6. The transmission tower according to claim 1, further comprising a tension fitting, wherein a first mounting hole is provided on each wire attaching plate, an end of the tension fitting is fixedly connected to the first mounting hole, and another end of the tension fitting is configured to attach the first conductor.

7. The transmission tower according to claim 6, wherein the tension fitting includes:
a first tension connecting plate;
a second tension connecting plate spaced apart from the first tension connecting plate; and
two first tension connectors, each having a first end connected to the first tension connecting plate, and a second end connected to the second tension connecting plate.

8. The transmission tower according to claim 6, wherein the tension fitting includes a first tension connecting plate, two first tension connectors and two second tension connectors, and
wherein the two second tension connectors are in one-to-one correspondence with the two first tension connectors, and the two second tension connectors are connected to the first tension connecting plate by respective first tension connectors.

9. The transmission tower according to claim 1, wherein the jumper connector is located at a bottom of the connecting part, and located between the two wire attaching plates, and a wire-attaching fitting string is attached on the jumper connector and configured to attach the first jumper.

10. The transmission tower according to claim 1, further comprising two composite crossarms disposed on the tower body at a same height, and axially symmetrically distributed relative to an axis of the tower body,
the two composite crossarms have axes coinciding with each other, to form a composite crossarm assembly, and
three composite crossarm assemblies are arranged on the tower body from bottom to top sequentially, and configured to attach double-circuit conductors.

11. The transmission tower according to claim 1, further comprising two composite crossarms disposed on the tower body at a same height, and are axially symmetrically distributed relative to an axis of the tower body,
the two composite crossarms have axes coinciding with each other, to form a composite crossarm assembly, and
six composite crossarm assemblies are arranged on the tower body from bottom to top sequentially, and configured to attach four-circuit conductors.

12. The transmission tower according to claim 1, further comprising:
an earth wire peak disposed at a top of the tower body;
a jumper string vertically attached at an end of the earth wire peak away from the tower body; and
a tension insulator string disposed on the tower body and positioned below the jumper string,
wherein a second jumper is attached between the tension insulator string and the jumper string;
the composite crossarm is located below the tension insulator string; and an end of the tension insulator string away from the tower body is configured to attach a second conductor.

13. The transmission tower according to claim 12, wherein the tension insulator string includes:
two tension insulators disposed parallel to each other;
a first fixing fitting; and
a second fixing fitting,
wherein a first end of each of the two tension insulators is fixedly connected to the tower body by the first fixing fitting, and a second end of each of the two tension insulators is configured to attach the second conductor by means of the second fixing fitting.

14. The transmission tower according to claim 13, further comprising two tension insulator strings provided, and the two tension insulator strings symmetrically distributed on the two sides of the tower body in an extending direction of the second conductor.

15. The transmission tower according to claim 13, wherein the first fixing fitting includes:
a first yoke plate;
a first adjusting fitting; and
second adjusting fittings,
wherein an end of the first yoke plate adjacent to the tower body is connected to the tower body by the first adjusting fitting, and another end of the first yoke plate is fixedly connected to the tension insulators by the second adjusting fittings.

16. The transmission tower according to claim 13, wherein the second fixing fitting includes:
a second yoke plate; and
a third adjusting fitting,
wherein an end of the second yoke plate adjacent to the tower body is directly fixedly connected to the tension insulators, and another end of the second yoke plate is connected to the second conductor in an adjustable position by means of the third adjusting fitting.

17. The transmission tower according to claim 16, wherein the third adjusting fitting includes a DB-type adjusting plate and a U-type fitting, and wherein the DB-type adjusting plate includes a plurality of mounting parts that are arranged in an arc shape, and the U-type fitting is selectively connected to one of the mounting parts.

18. The transmission tower according to claim 12, further comprising a fixing part provided on the top of the tower body, and wherein an end of the earth wire peak is fixedly connected to the tower body by the fixing part, and another end of the earth wire peak is connected to the jumper string.

19. The transmission tower according to claim 13, wherein the jumper string includes:
two jumper insulators disposed parallel to each other;
a third fixing fitting; and
a wire attaching fitting,
wherein first ends of the two jumper insulators are fixedly connected to the earth wire peak by the third fixing fitting, and second ends of the two jumper insulators are configured to attach the second jumper by means of the wire attaching fitting.

20. The transmission tower according to claim 19, wherein the second jumper is electrically connected to second conductors located on the two sides of the tower body.
